(19) United States
(12) Patent Application Publication
(10) Pub. No.: US 2010/0180651 A1
(43) Pub. Date: Jul. 22, 2010

(54) LOCK DEVICE

(76) Inventor: Daniel Andersson, Eskilstuna (SE)

Correspondence Address: HOLLAND & HART, LLP, P.O BOX 8749, DENVER, CO, 80201, US

(21) Appl. No.: 12/527,852

(22) PCT Filed: Feb. 21, 2008
(86) PCT No.: PCT/SE08/00144

§ 371 Date: Nov. 24, 2009

(30) Foreign Application Priority Data
Feb. 21, 2007 (SE) 0700421-1

(51) Int. Cl. E05B 47/06; E05B 17/04; E05B 9/04

(52) U.S. Cl. 70/449

(57) ABSTRACT

A lock device comprises a cylinder housing (10) with a cavity (12) and a substantially cylindrical cylinder core (20), which is rotatably accommodated in the cavity. A tailpiece (50) arranged to cooperate with a lock mechanism. An adapter (40) is rotatably accommodated in the cavity in the cylinder housing and axially connected to the tailpiece First means for interconnecting the adapter and the cylinder core are arranged to allow mutual and free independent rotation of the core and adapter in a locked operational mode and to prevent mutual rotation in an unlocked operational mode. Second means for interconnecting the adapter and the core are arranged to fix the cylinder core against axial displacement relative to the cylinder house in both operational modes for the first means.

### FIELD OF INVENTION

The present invention relates generally to lock devices and more particularly to a modular lock cylinder having a free-turning function between the cylinder core and the tailpiece.

### BACKGROUND

Lock cylinders are arranged to transfer a rotational movement from a cylinder core to a tailpiece provided to actuate a lock mechanism in for example a lock case. The cylinder core can be turned by means of e.g. a key or a knob. In many lock cylinders, a blocking mechanism is provided to allow only an authorized user to operate the lock cylinder. This blocking mechanism prevents turning of the cylinder core for example in the case an incorrect key is inserted in the lock cylinder.

As an alternative to a blocking mechanism preventing turning of the cylinder core, an arrangement can be provided which decouples or disconnects the cylinder core from the tailpiece. In this case, when an incorrect key is inserted in the lock cylinder, the cylinder core can be freely rotated without causing rotation of the tailpiece. This prevents the lock device from being readily wrenched or pried apart.

The lock industry is faced with demands on cost reductions and one way of meeting this demand is to use the same kind of components in different lock configurations. This however requires modularity in the design of the different parts making up the lock devices. This is particularly true in electronic or electro-mechanical lock devices, wherein the cost for the electronic components is drastically reduced with large-scale production.

### SUMMARY OF THE INVENTION

An object of the present invention is to provide a lock device of the kind initially mentioned which has a simple design and readily adapts itself for different configurations of the cylinder housing and the tailpiece.

The invention is based on the realisation that the cylinder core and the tailpiece of a lock cylinder can be interconnected by means of an adapter, wherein there is a free-turning function between the cylinder core and the adapter.

According to the invention there is provided a lock device lock device comprising a cylinder housing with a cavity; a substantially cylindrical cylinder core, which is rotatably accommodated in the cavity in the cylinder housing; a tailpiece arranged to cooperate with a lock mechanism; and an adapter, which is rotatably accommodated in the cavity in the cylinder housing, wherein the adapter is axially connected to the tailpiece. The lock device also comprises first means for interconnecting the adapter and the cylinder core, which first means are arranged to allow mutual and free independent rotation of the cylinder core and the adapter in a locked operational mode and to prevent mutual rotation in an unlocked operational mode; and second means for interconnecting the adapter and the cylinder core, which second means are arranged to fix the cylinder core against axial displacement relative to the cylinder house in the locked as well as the unlocked operational mode for the first means.

Thus there is provided a lock device having a simple design and which still is easy to adapt to different configurations. Since the first interconnecting means, in the locked mode, allow mutual and free independent rotation of the cylinder core and the adapter, both the core and the adapter may have any rotational orientation when the operational mode for the first means is changed from locked to unlocked. The free rotation of the adapter will then allow then adapter to rotate to a rotational position at which the first interconnection means may engage. Since the second interconnection means in both operational modes prevents axial displacement of the core relative to the cylinder house, the core is securely prevented from being extracted from the house.

In a preferred embodiment, the second means for interconnecting the adapter and the cylinder core comprises a circumferential groove on the adapter near a first end portion thereof facing the cylinder core and a recess in an end portion of the cylinder core facing the adapter. This configuration is easy to provide and allows simple manufacturing.

In another preferred embodiment, the tailpiece has a diameter, which is larger than the diameter of the cavity in the cylinder housing, allowing for axial fixation of the adapter and the cylinder core.

Further preferred embodiments are defined by the dependent claims.

### BRIEF DESCRIPTION OF DRAWINGS

The invention is now described, by way of example, with reference to the accompanying drawings, in which:

FIG. 1 is an overall view of the lock device according to the invention;

FIGS. 2 and 3 are exploded perspective views of the lock device of FIG. 1;

FIG. 4 is an enlarged view of an adapter comprised in the lock device; and

FIGS. 5 and 6 are plan views showing the adapter of FIG. 4 and a cylinder core disconnected and interconnected, respectively.

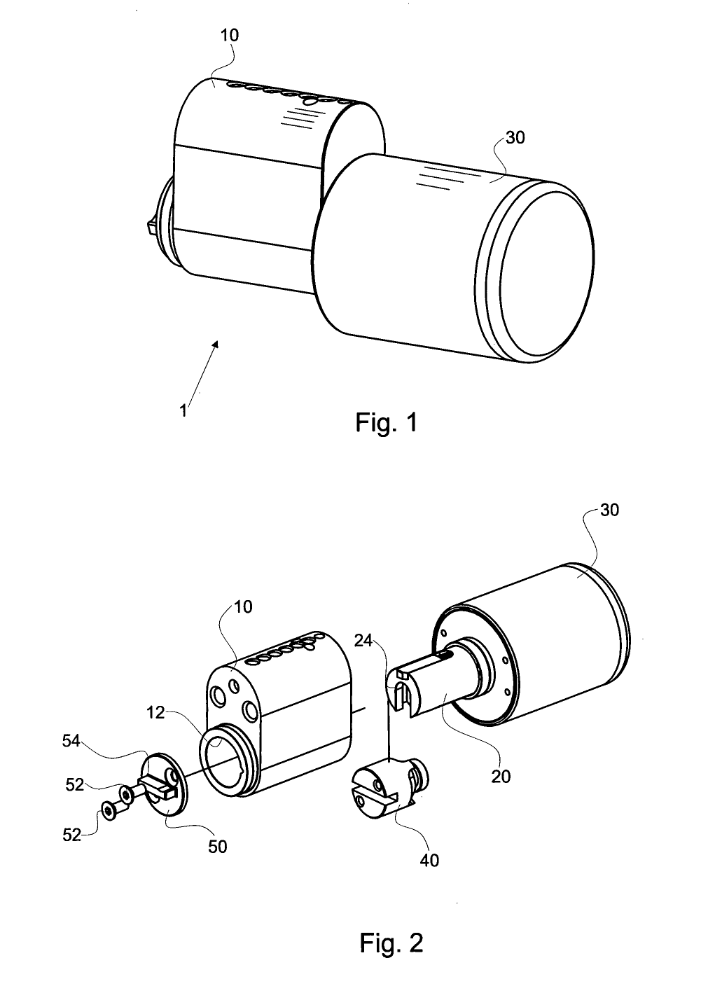

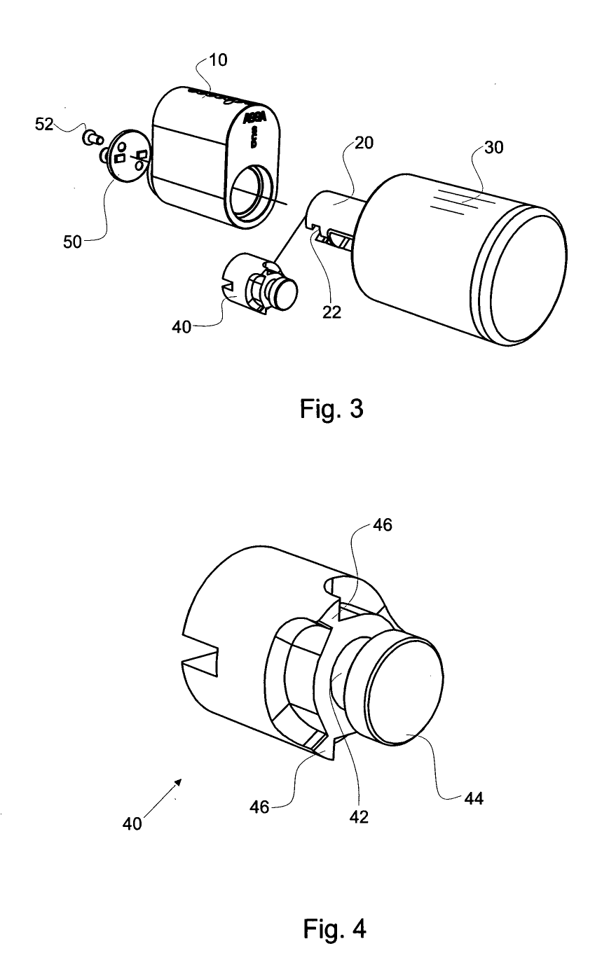

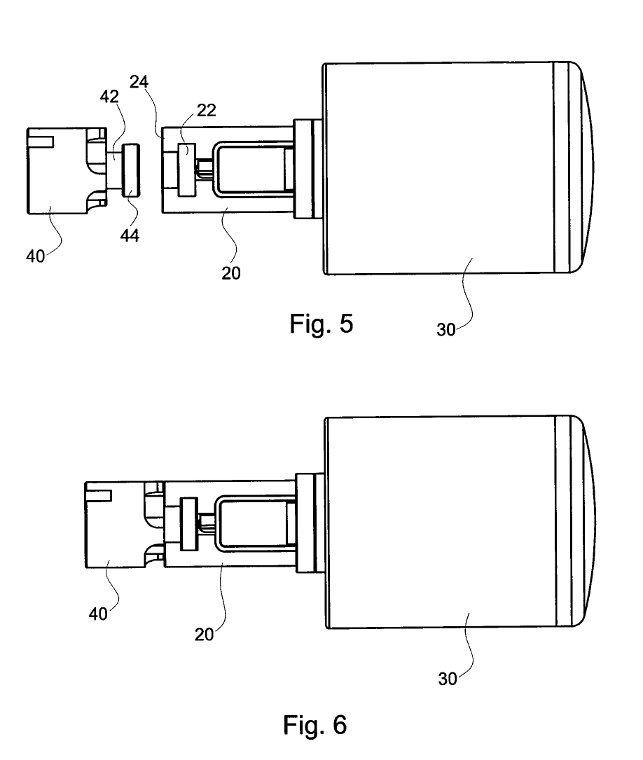

### DETAILED DESCRIPTION OF THE INVENTION

In the following a detailed description of a preferred embodiment of the present invention will be given. In this description, references will be made to directions, such as upper and lower. It will be realized that these references are non-limiting and only refer to the directions shown in the figures.

A lock cylinder, generally designated 1, comprises a cylinder housing 10 having a circular cavity or bore 12 extending axially through the full length of the cylinder housing. A cylindrical cylinder core 20 having a longitudinal axis is arranged rotatably in the cavity as will be explained below. A knob 30 is fixedly attached to the outer end portion of the cylinder core 20 and comprises electronic authorization means, such as a microprocessor, control electronics, antenna etc. (not shown).

An adapter 40 is arranged for insertion into the cavity 12 in the cylinder housing 10. Thus, the adapter has an overall cylindrical shape allowing rotation in the cylinder housing cavity. A circumferential groove or waist portion 42 is provided on the adapter near a first end portion 44 thereof facing the cylinder core 20. This groove and the end portion of the adapter are arranged to cooperate with a recess 22 in the end portion 24 of the cylinder core 20 facing the adapter 40. In other words, the end portions of the adapter and the cylinder core interact in an axial direction in a dovetail like fashion so that they are axially linked in when interconnected.

The adapter 40 is provided with a plurality of radially spaced flanges 46, see FIG. 4. These flanges are arranged to cooperate with movable interlocking means in the cylinder core 20. In axially extended position of the interlocking means, i.e., when the interlocking means extend so that it overlaps the flanges 46 in an axial direction, mutual rotation between adapter and cylinder core is blocked. In axially retracted position of the interlocking means, mutual free-turning rotation between adapter and cylinder core is allowed.

The engagement between the end portions of the adapter and the cylinder core prevents mutual axial movement between the adapter and the cylinder core while allowing mutual rotational movement there between in a free-turning operational mode. Thus, during assembly of the lock device, the end portion 44 of the adapter is inserted into the recess 22 of the cylinder core before inserting the adapter 40 into the cavity 12 of the cylinder housing 10. In this way, the adapter and the cylinder core make up one single unit before insertion into the cylinder housing.

A tailpiece 50 is attached to the end surface of the adapter opposite to the first end portion thereof by means of two screws 52. This tailpiece has a diameter, which is larger and preferably only slightly larger than the diameter of the cavity 12 in the cylinder housing 10. This means that when the adapter 40 and the cylinder core 20 are interconnected and the tailpiece 50 is attached to the adapter, the arrangement comprising these parts is fixed against axial movement in the cylinder housing 10.

An integrated coupling 54 is arranged on the end surface of the tailpiece 50, being arranged to cooperate with a lock mechanism provided in a lock case, for example.

The provision of an adapter between the cylinder core and the tailpiece makes possible the use of a single type of cylinder core in many types of cylinder housings and together with different types of tailpieces. This in turn reduces the total production costs since the cost for the adapter itself is relatively low.

The operation of the lock device 1 will now be explained. In a first mode of operation, the interlocking means provided in the cylinder core 20 is retracted, resulting in free-turning operation. This means that when the knob 30 is turned, the cylinder core 20 turns therewith but the adapter and tailpiece do not, resulting in a locked state of the lock device. If the interlocking means is moved to an extended position, such as by means of an electronic arrangement controlled by means of a remote control, the adapter and tailpiece turn with the knob, resulting in an unlocked state of the lock device.

A preferred embodiment of a lock device according to the invention has been described. A person skilled in the art realises that this could be varied within the scope of the appended claims. Thus, a knob-operated lock cylinder has been shown and described. It will be realized that the inventive idea is applicable also for other kinds of lock cylinders, such as key operated ones.

A separate tailpiece 50 has been described. It could also be integral with the adapter 40. In this case, the adapter must be inserted from behind and the knob 30 be attached to the cylinder core 20 after insertion thereof.

Instead of axial fixation by means of a tailpiece having a larger diameter than the cavity 12 in the cylinder housing, a ring or the like could be attached to the adapter in a circumferential groove in the adapter or a pin be provided in a hole in the barrel surface of the adapter.

1. A lock device comprising:
a cylinder housing (10) with a cavity (12);
a substantially cylindrical cylinder core (20), which is rotatably accommodated in the cavity in the cylinder housing;
a tailpiece (50) arranged to cooperate with a lock mechanism; and
an adapter {40), which is rotatably accommodated in the cavity in the cylinder housing, wherein the adapter is axially connected to the tailpiece,
characterized by
first means for interconnecting the adapter and the cylinder core which first means are arranged to allow mutual and free independent rotation of the cylinder core and the adapter in a locked operational mode and to prevent mutual rotation in an unlocked operational mode; and
second means for interconnecting the adapter and the cylinder core, which second means are arranged to fix the cylinder core against axial displacement relative to the cylinder house in the locked as well as the unlocked operational mode for the first means.

2. The lock device according to claim 1, wherein the second means for interconnecting the adapter (40) and the cylinder core (20) comprises a circumferential groove (42) on the adapter near a first end portion (44) thereof facing the cylinder core and a recess (22) in an end portion (24) of the cylinder core facing the adapter.

3. The lock device according to claim 1, wherein the second means comprise a plurality of flanges {46) arranged at the adapter (40) to cooperate with movable interlocking means in the cylinder core (10).

4. The lock device according to claim 3, wherein the 10 plurality of flanges (46) are radially spaced.

5. The lock device according to claim 3, wherein the movable interlocking means in the cylinder core (10) are axially movable.

6. The lock device according to claim 1, wherein the tailpiece (50) has a diameter, which is larger than the diameter of the cavity (12) in the cylinder housing (10).

7. The lock device according to claim 1, comprising a knob (30), which is fixedly attached to the outer end portion of the cylinder core (20).

8. The lock device according to claim 1, comprising an electronic authorization means.

9. The lock device according to claim 1, wherein the electronic authorization means is provided in the knob (30).

10. The lock device according to claim 1, wherein, the tailpiece (50) is provided as a separate part.

11. The lock device according to claim 1, wherein the tailpiece (50) is provided integral with the adapter.
